(19) United States
(12) Patent Application Publication
(10) Pub. No.: US 2008/0222350 A1
(43) Pub. Date: Sep. 11, 2008

(54) Flash memory device for storing data and method thereof

(76) Inventor: Shih-Chieh Chang, Hsin-Chu City (TW)

Correspondence Address: TROXELL LAW OFFICE PLLC, SUITE 1404, 5205 LEESBURG PIKE, FALLS CHURCH, VA, 22041, US

(21) Appl. No.: 12/073,506

(22) Filed: Mar. 6, 2008

(30) Foreign Application Priority Data
Mar. 9, 2007 (TW) 096108138

(51) Int. Cl. G06F 12/00

(52) U.S. Cl. 711/103; 711/E12.001

(57) ABSTRACT

A flash memory device which comprises a controller and one or plurality of flash memories for storing data and method thereof are disclosed. The controller comprises a control interface to accept data access which is from a main board and is managed by a control element of flash memory and a buffer management element. Through a micro-processing element in the controller, the data access from main board is checked for a random access or a serial page access. The random access and serial page access are written to different blocks by different processes in one or plurality of flash memories. The lifetime and processing speed of flash memories are improved for reduced erasure times during writing data.

### BACKGROUND OF THE INVENTION

1. Field of the Invention

This invention relates to a flash memory device for storing data and, more particularly, to a device and a method thereof of managing a flash memory whose blocks are sorted to store different species data for different commands from main board.

2. Description of the Prior Art

Flash memories are electrically erasable semiconductor memory devices that can be erased and rewritten. As a non-volatility memory, flash memories are popular used in embedded systems to store essential data and whose rewriting rate is relative low than volatility memories (e.g. SRAM and DRAM). As well known in the art, no data can be rewritten in the written memory area before erasure. If the management of erasing and rewriting cycle is not very efficient, the flash memory reacting rate can not match the high data transfer rate. Finally, the data transfer rate is dragged for the flash memory.

The working principle of flash memories is to charge floating gate of transistors which are bit elements in flash memory for writing data. A charged floating gate rises transistor threshold voltage and presents no drain-to-source current as reading (so-called state=“0”). In the other hand, an uncharged floating gate presents a state=“1”. Once a floating gate is charged, the state of the current transistor is set and can not be changed before erasure. The erasure is block erasure. That means floating gate of whole block transistors is all discharged to state=1 as block erasure. When the size of storing data is less than one block, the data transfer is a random access. On the other hand, it is a serial page access. An example of a conventional data transfer approach for flash memories is described as FIG. 5 and FIG. 6. As FIG. 5A and FIG. 5B shown, a first random access to a page A in current block whose rest pages are written is referred to a page B whose page address is the same as page A in an empty random block by a management element. And, all valid data in current block is copied to the same page address in the random block (please see FIG. 5C). After the copy is completed, the current block erasure is processes and then block address for current block and the random block are exchanged. As shown in FIG. 5D, the valid data has successfully been extended for the first random access in current block during move, copy, and erasure. Follow this move, copy, and erasure cycle. The more data access can be continued to the rest part of current block.

FIG. 6 shows a conventional example for a first serial page access. When the first serial page access to a first block is suffering a page N with valid data, it is continued to page 1 of a second block. However, if the page 1 of second block has a valid data too (as FIG. 6A), the first serial page access is continued to page 1 of a serial block for the same size of rest part of the first block from page N (as FIG. 6B). And, the valid data in the second block is copied to the serial block for later second block erasure (as FIGS. 6C and 6D). Certainly, the block address for second block and serial block are exchanged (as FIG. 6E) to change current block address.

During the cycle of page copies, block erasure and address exchange, the written current block can be rewritten for more data access. However, in every data access, the cycle of page copy and block erasure has to be done repeatedly. It takes a certain time for page copy and block erasure (charging and discharging). Besides, charging and discharging on the floating gate is not unlimited. Repeated block erasure in every rewriting process consumes lifetime of flash memories and also drags data transfer rate.

If the rewriting cycle can be used more efficiently and the redundant page copy and block erasure can be compressed, it will improve the performance and extend the lifetime of flash memories.

### SUMMARY OF THE INVENTION

An object of the present invention is to provide a flash memory device which comprises a micro-processing element to separate random access and serial page access for different storing and method thereof are disclosed in the present invention. Because the random access and serial page access are separated, the rewriting cycle can be used more precisely for different conditions and the processing time can be speeded up too.

A further object of the present invention is to provide a flash memory device whose blocks are sorted to store random access and serial access separately and method thereof are disclosed in the present invention. Because data size of random access and serial page access are different, the sorted blocks can help to reduce cycle of page copy and block erasure.

In general, the writing flowchart of method thereof comprises the following three steps: (a) accepting a data transfer command for data access; (b) separating the random access and serial page access by their data size through a micro-processing element; and (c) processing the random access or the serial page access to one or plurality of flash memories through a control element of flash memory.

The flash memory device for storing data provided in the present invention comprises: a controller and one or plurality of flash memories. The controller consists of a control interface, a control element of flash memory, a buffer management element and a micro-processing element. The control interface is an interface to accept the transferring data for flash memories. The control element of flash memory has an electrical connection to the control interface and an electrical connection to the one or plurality of flash memories in order to control the random access and serial page access. The buffer management element has an electrical connection to the control interface and an electrical connection to the control element of flash memory in order to control a buffer as data transferring. The micro-processing element has an electrical connection to the control interface, an electrical connection to the control element of flash memory, an electrical connection to the buffer management element and one or plurality of electrical connection to RAM/ROM in order to check data size and separate the random access and serial page access for writing to the one and plurality of flash memories through the control element of flash memory.

For a more complete understanding of the features and advantages of the present invention, reference is now made to the following description taken in conjunction with accompanying drawings, in which:

### BRIEF DESCRIPTION OF THE DRAWINGS

FIG. 1 shows a sketch of an embodiment for the flash memory device in the present invention.

FIG. 2 shows a general flowchart for the flash memory device and method thereof in the present invention.

FIG. 3A-3D show a working procedure of an embodiment for a random access to the flash memory device in the present invention.

FIG. 4A-4E show a working procedure of an embodiment for a serial page access to the flash memory device in the present invention.

FIG. 5A-5D show a conventional working procedure for a random access to the flash memory device.

FIG. 6A-6E show a conventional working procedure for a serial page access to the flash memory device.

### DETAILED DESCRIPTION OF THE PREFERRED EMBODIMENTS

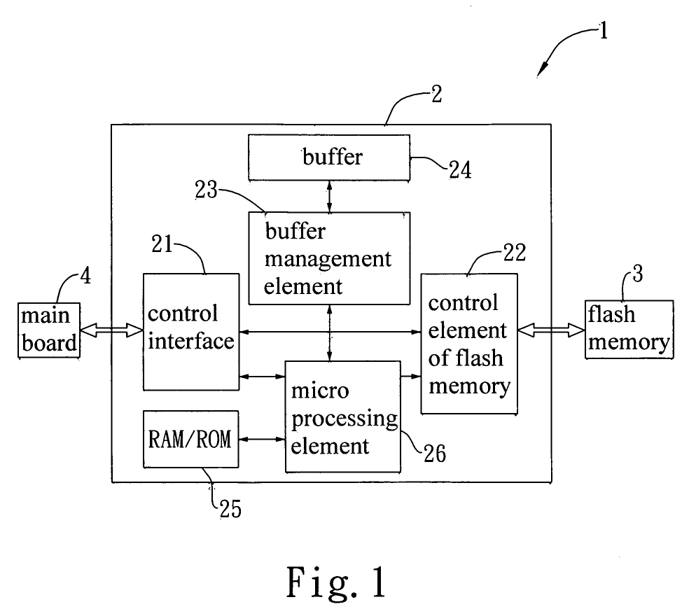

An embodiment of the flash memory device 1 in the present invention is shown in FIG. 1. The flash memory device comprises: a controller 2 and one or plurality of flash memories 3. The controller 2 consists of: a control interface 21, a control element of flash memory 22, a buffer management element 23, a buffer 24, one or plurality of random access memories or read only memories (RAM/ROM) 25 and a micro-processing element 26.

The control interface 21 can be the spec of universal serial bus (USB) or IEEE1394 or the other similar spec to accept transferring data from a main board 4.

The control element of flash memory 22 has an electrical connection to the control interface 21 and one or plurality electrical connection to the flash memories 3 for data transferring.

The buffer management element 23 has an electrical connection to the control interface 21 and an electrical connection to the control element of flash memory 22 in order to manage a buffer 24 for data access from the main board 4.

The micro-processing element 26 has an electrical connection to the control interface 21, an electrical connection to the control element of flash memory 22, an electrical connection to the buffer management element 23 and an electrical connection to one or plurality of RAM/ROM 25. The micro-processing element 26 can read size of transferring data from FAT at the main board 4 to decide the transferring data is a random access or a serial page access. After the random access or serial page access is decided, the micro-processing element will inform the control element of flash memory 22 to write data access to the one or plurality of flash memories 3.

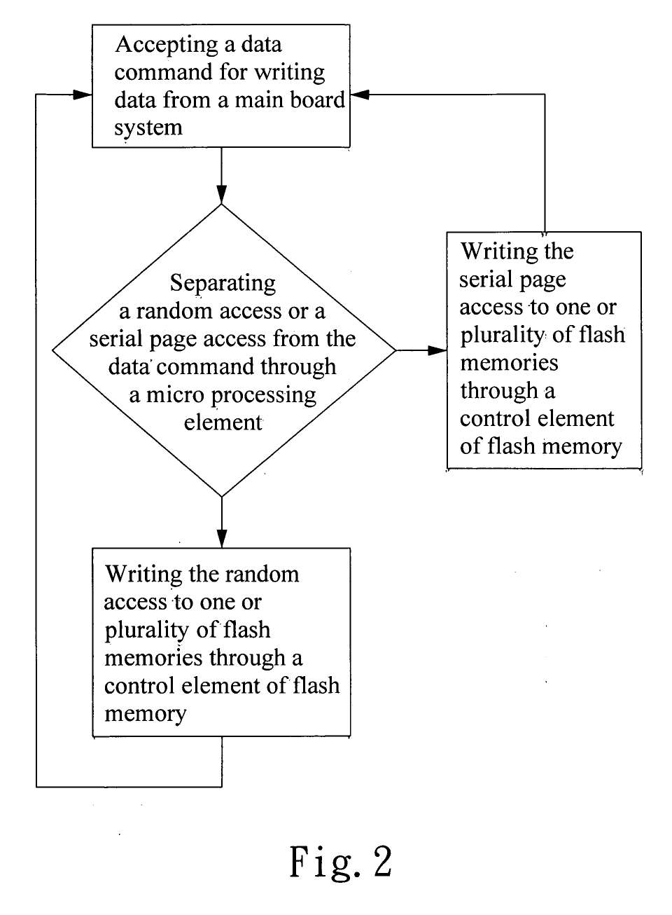

As FIG. 2 shown, the method thereof in the present invention comprises the following steps:
a) Accepting a data transferring from a main board system.
b) Checking the data size for separating a random access or a serial page access through a micro-processing element.
c) Writing the random access or serial page access to one or plurality of flash memories respectively by a control element of flash memory.

In the embodiment of method thereof, the checking size of transferring data in step (b) is to check file information from the FAT of main board 4.

Every transferring data from the main board 4 follows the three steps (a), (b) and (c) to complete writing on the flash memories.

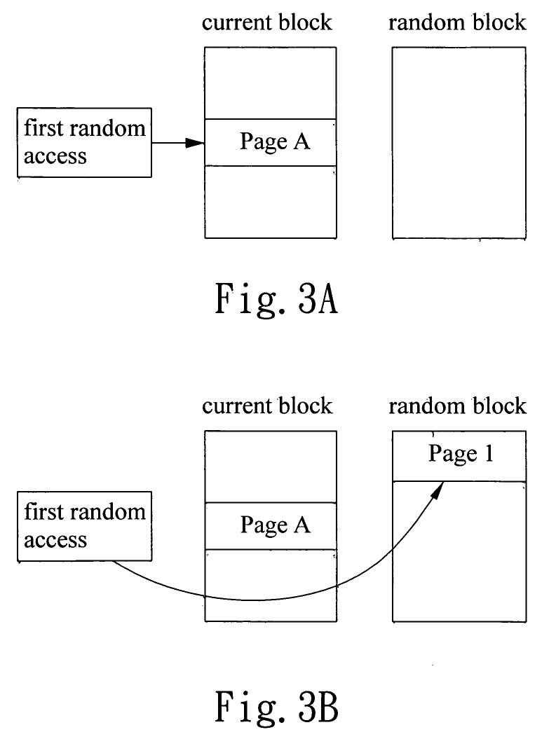

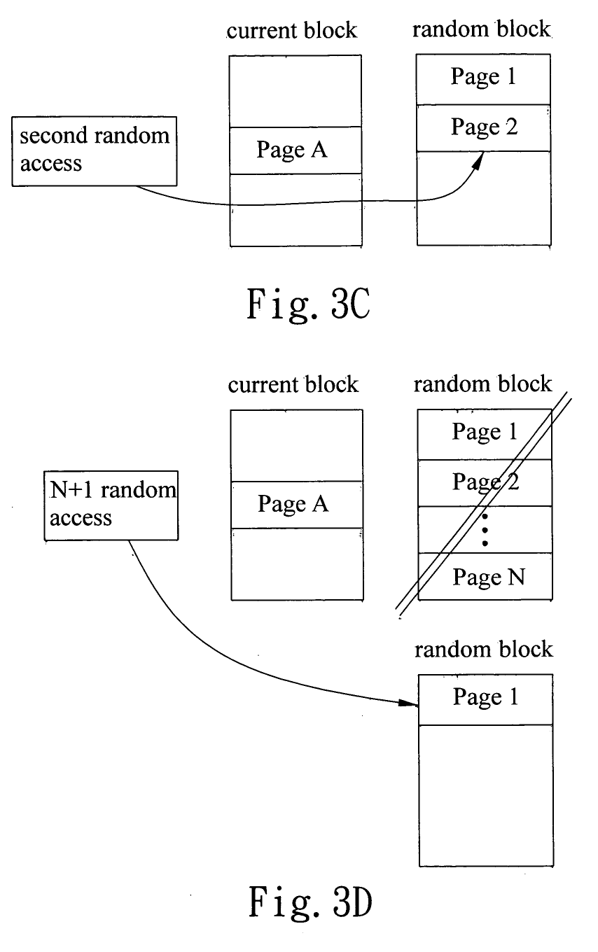

FIG. 3A-3D show a working procedure of the embodiment for a random access to the flash memory device in the present invention. When a first transferring data is checked for a random access, its accessing address is changed from page A of current block to page 1 of an empty random block (as FIGS. 3A and 3B). Because the address is changed, there is a mapping table for mapping these two addresses. When a second transferring data is also a random access, which is checked by the micro-processing element 26, its address will be referred to page 2 of the random block as FIG. 3C. Consequently, an N^{th} transferring data for random access which is checked by the micro-processing element will access to page N of the random block. If the (N+1)^{th} transferring data is also a random access and the random block is already full in N pages, the random block will process block erasure in order to release an empty random block for the (N+1)^{th} transferring data access (as FIG. 3D). Then, the (N+1)^{th} transferring data can access to page 1 of the empty random block. The data behind (N+1)^{th} transferring data for random access is continued to page 1 of the random block until it turns to be a serial page access.

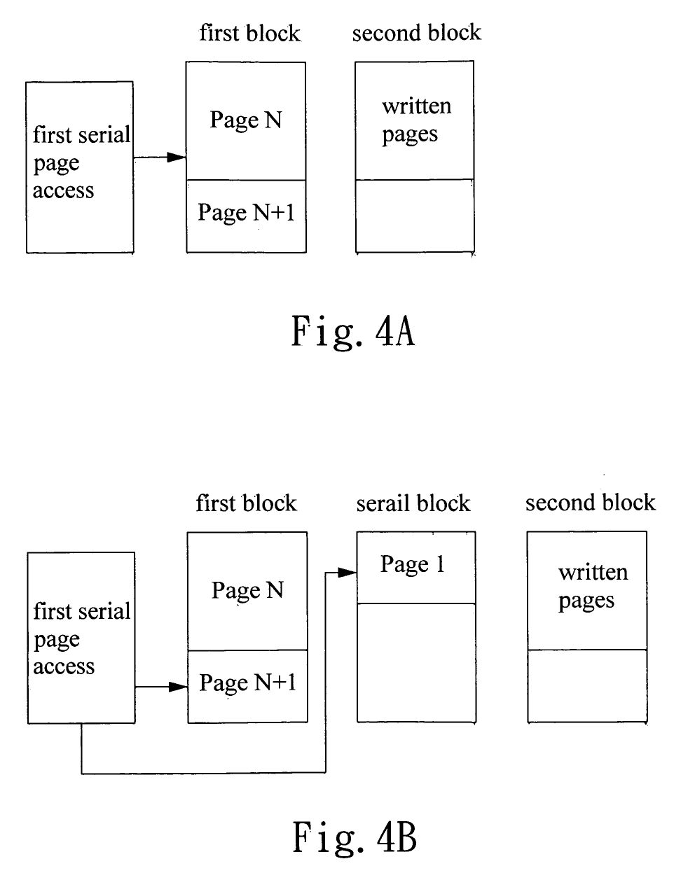

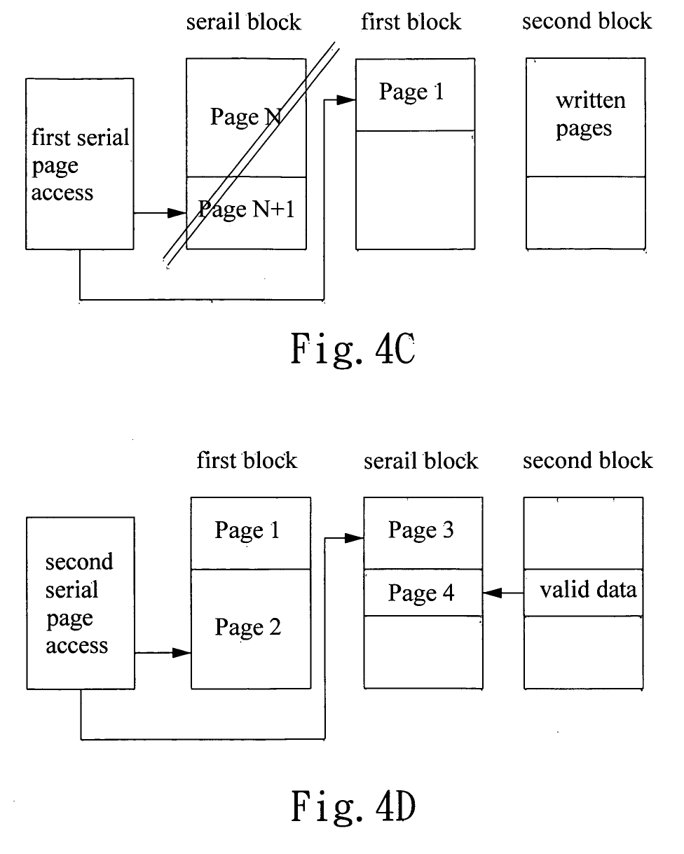

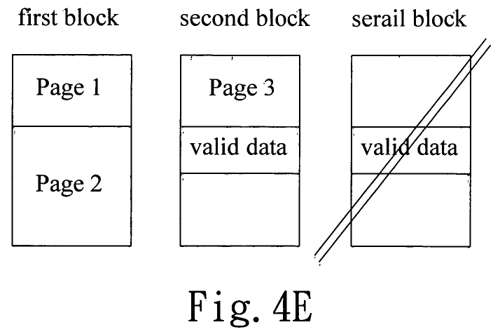

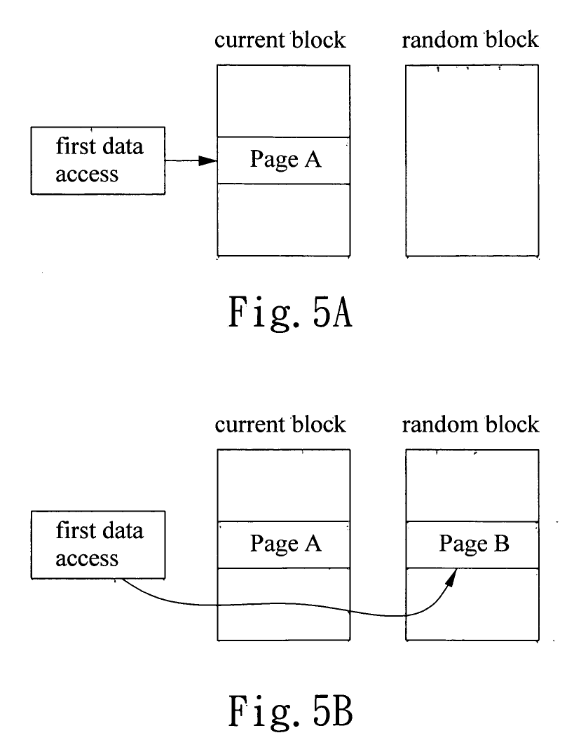

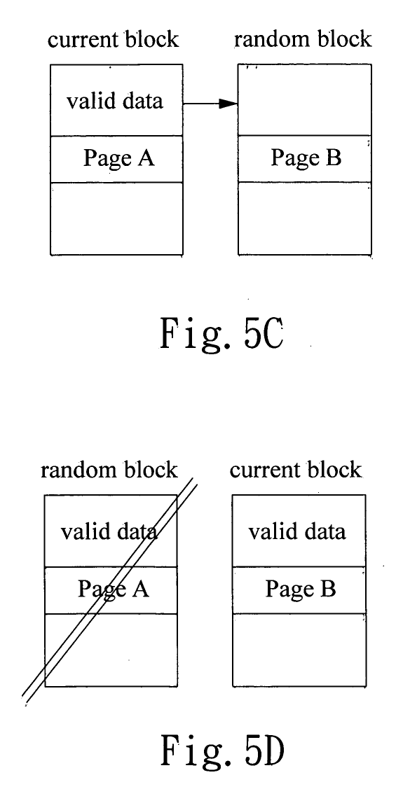

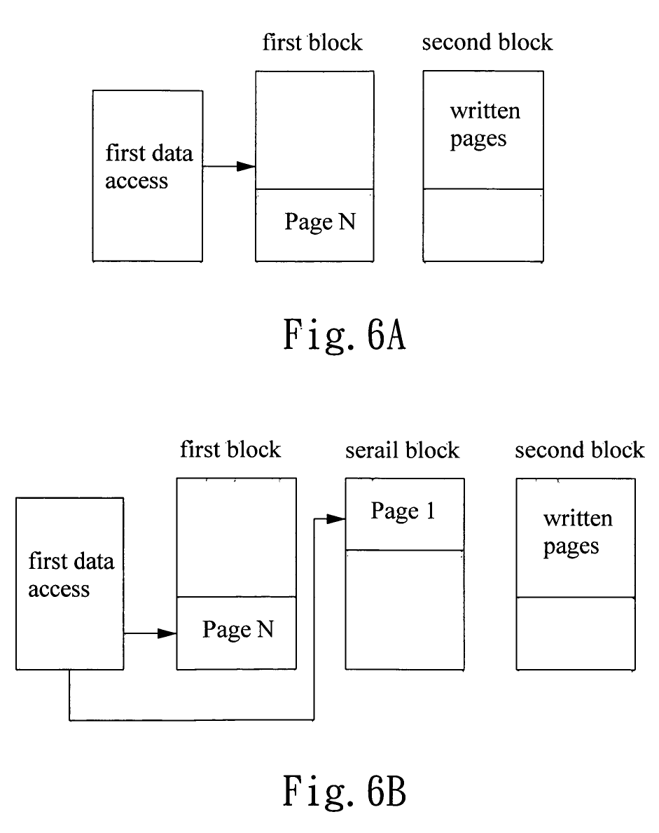

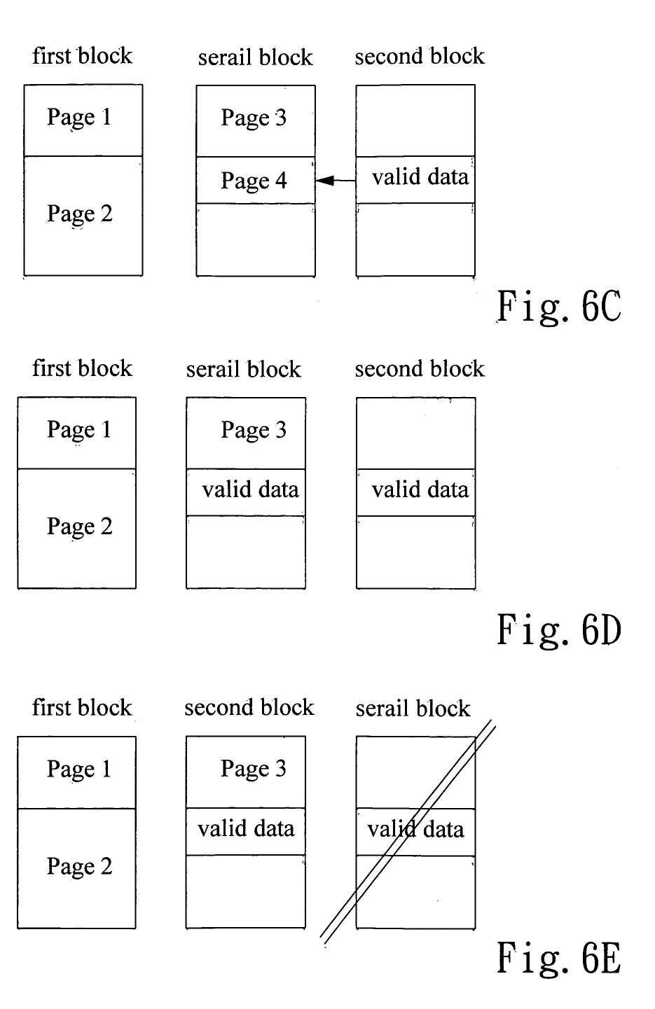

FIG. 4A-4E show a working procedure of an embodiment for a serial page access to the flash memory device in the present invention. When a first transferring data is serial page access and is continued to the end of a first block (current block), its address is referred to a second block for continue access (as FIG. 4A). If the page in the second block is written, its address will be referred to page 1 of an empty serial block (as FIG. 4B). As shown in FIG. 4C, the first block processes block erasure in order to release an empty serial block and the serial page is changed as current block (the first block). When a second transferring data is also a serial page access, its address is continued to the end of the first transferring data (such as the page 2 and page 3 of current block in FIG. 4D). When a third transferring data is not serial page access anymore, the valid data in the second block is copied to page 4 of current block and the second block processes block erasure in order to release an empty serial block as FIG. 4E.

Consequently, the random access and serial page access from the main board can be processed by different procedures. In the present invention, erasure is not necessary in every data access. Because times of block erasure is compressed, lifetime of flash memories is saved and processing time of flash memories is speeded up too.

It should be understood that different modifications and variations could be made from the disclosures of the present invention by the people familiar in the art, which should de deemed without departing the spirit of the present invention.

What is claimed is:

1. A method for managing flash memory device to store data comprises the following steps:
(a) Accepting a data command for writing data from a main board system;
(b) Separating a random access or a serial page access from the data command through a micro-processing element; and
(c) Writing the random access or the serial page access to one or plurality of flash memories through a control element of flash memory.

2. A method for managing flash memory device to store data according to claim 1, wherein the micro-processing element separates a random access or a serial page access by the data size which is provided by the main board system.

3. A method for managing flash memory device to store data according to claim 1, wherein the micro-processing element separates a random access or a serial page access by the data size which is provided by the File Allocation Table (FAT) in main board system.

4. A method for managing flash memory device to store data according to claim 1 also comprises when the transferring data being decided as random access through a micro-processing element: writing a first random access to an empty random block and mapping current block address to the random block address through a mapping table.

5. A method for managing flash memory device to store data according to claim 4 also comprises the following steps: (a) writing a second random access to next page of the end of the first random access and making the mapping table to map the address of second random access; and (b) erasing the random block which is fully written in order to release an new empty random block for the next random access.

6. A method for managing flash memory device to store data according to claim 1 also comprises the following steps when the transferring data being decided s a serial page access through a micro-processing element: (a) writing a first serial page access to a first block and continuously writing to a second block when the first block is full; (b) continuously writing the first serial page access to a empty serial block when the second block is written; (c) writing a second serial page access to next page of the end of first serial page access; (d) coping the valid data of the second block to next page of the end of second serial page access when the next data access is not a third serial page access; and (e) exchanging the block address between the serial block and the second block and erasing the serial block for releasing an empty serial block.

7. A method for managing flash memory device to store data according to claim 6 also comprises the following step: exchanging the block address between the serial block and the first block and erasing the serial block for releasing an empty serial block.

8. A flash memory device for storing data which, comprises a controller and one or plurality of flash memories, wherein, the controller comprises:
a control interface which has an electrical connection to a main board for accepting data access from the main board;
a control element of flash memory which has an electrical connection to the control interface and an electrical connection to the one or plurality of memories in order to control data access from the main board;
a buffer management element which has an electrical connection to the control interface and an electrical connection to the control element of flash memory in order to manage a buffer for data access from the main board; and
a micro-processing element has an electrical connection to the control interface, an electrical connection to the control element of flash memory, an electrical connection to the buffer management element, and one or plurality of electrical connections to a Random Access Memory or Read Only Memory (RAM/ROM) in order to check the data access from main board is a random access or a serial page access and write the random access or serial page access to one or plurality of flash memories.

9. A flash memory device for storing data according to claim 8, wherein the micro-processing element checking the data access from main board is a random access or a serial page access by the size of data.

10. A flash memory device for storing data according to claim 8, wherein the micro-processing element checking the data access from main board is a random access or a serial page access by the size of data which is read from the File Allocation Table (FAT) of file system of main board.
